(19) United States
(12) Patent Application Publication
(10) Pub. No.: US 2023/0296954 A1
(43) Pub. Date: Sep. 21, 2023

(54) ELECTROCHROMIC DEVICE AND MANUFACTURING METHOD THEREOF

(71) Applicant: ELECTRONICS AND TELECOMMUNICATIONS RESEARCH INSTITUTE, Daejeon (KR)

(72) Inventors: Chil Seong AH, Daejeon (KR); Hojun RYU, Daejeon (KR); Juhee SONG, Daejeon (KR); Sang Hoon CHEON, Daejeon (KR)

(21) Appl. No.: 18/077,377

(22) Filed: Dec. 8, 2022

(30) Foreign Application Priority Data
Mar. 21, 2022 (KR) 10-2022-0034779

(51) Int. Cl. G02F 1/155; G02F 1/153; G02F 1/1516

(52) U.S. Cl. CPC G02F 1/155; G02F 1/1533; G02F 1/15165

(57) ABSTRACT

Provided is a method for manufacturing an electrochromic device, the method including forming a first electrode on a first flexible substrate, forming an electrochromic layer on the first electrode, etching the electrochromic layer to form electrochromic pixel patterns, etching the first electrode to form fine pattern electrodes including first fine pattern electrode portions and second fine pattern electrode portions, forming an insulation film on upper surfaces of the second fine pattern electrode portions, and forming an electrolyte layer on the insulation film and on the electrochromic pixel patterns, wherein the electrochromic pixel patterns are disposed on upper surface of the first fine pattern electrode portions, and the etching of the first electrode and the etching of the electrochromic layer are performed in a single process.

### CROSS-REFERENCE TO RELATED APPLICATION

This U.S. non-provisional patent application claims priority under 35 U.S.C. § 119 of Korean Patent Application No. 10-2022-0034779, filed on Mar. 21, 2022, the entire contents of which are hereby incorporated by reference.

### BACKGROUND

### 1. Field of the Invention

The present disclosure herein relates to an electrochromic device and a manufacturing method thereof, and more specifically, to a flexible array electrochromic display device including a conductive polymer electrochromic material and a manufacturing method thereof.

### 2. Description of Related Art

Electrochromism refers to a phenomenon in which an electrochemical oxidation or reduction reaction of a chromic material causes the state of the material to be reversibly colored or bleached. As an electrochromic device, a material that is colored by receiving electrons or is colored by losing electrons may be used. The electrochromic device is a non-self-luminous information display device using an external light source, has good visibility outdoors, and shows a high contrast ratio in strong light. In addition, the electrochromic device is easily adjusted in transmittance by a driving voltage, has a low driving voltage, has a large view angle, and thus has been widely studied in various fields.

### SUMMARY

The present disclosure provides a method for manufacturing an electrochromic device with improved photoelectric operation properties.

The present disclosure relates to an electrochromic device and a manufacturing method thereof. An embodiment of the inventive concept provides a method for manufacturing an electrochromic device, the method including forming a first electrode on a first flexible substrate, forming an electrochromic layer on the first electrode, etching the electrochromic layer to form electrochromic pixel patterns, etching the first electrode to form fine pattern electrodes including first fine pattern electrode portions and second fine pattern electrode portions, forming an insulation film on upper surfaces of the second fine pattern electrode portions, and forming an electrolyte layer on the insulation film and on the electrochromic pixel patterns, wherein the electrochromic pixel patterns are disposed on upper surface of the first fine pattern electrode portions, and the etching of the first electrode and the etching of the electrochromic layer may be performed in a single process.

In an embodiment, the electrochromic pixel patterns may expose the upper surfaces of the second fine pattern electrode portions.

In an embodiment, the insulation film may not cover upper surfaces of the electrochromic pixel patterns.

In an embodiment, the electrochromic layer may include a conductive polymer.

In an embodiment, the forming of electrochromic pixel patterns and the forming of fine pattern electrodes may be performed by a single laser etching process.

In an embodiment, the forming of an insulation film may be performed by an e-beam vacuum deposition method using a mask.

In an embodiment, the electrolyte layer may include an adhesive polymer gel electrolyte.

In an embodiment, the insulation film may include a silicon oxide (SiO₂) or a metal oxide.

In an embodiment, the method may further include forming a second electrode on a lower surface of a second flexible substrate, forming an ion storage layer on a lower surface of the second electrode, and coupling the electrolyte layer and the ion storage layer.

In an embodiment, the method may further include forming a counter electrode connection portion. In an embodiment, the method may further include forming an electrode connection portion, wherein the electrode connection portion may electrically connect the counter electrode connection portion and the second electrode.

In an embodiment, the method may further include forming a bonding portion, wherein the bonding portion is electrically connected to the counter electrode connection portion and the second fine pattern electrode portions.

In an embodiment, the method may further include forming a first glass layer on a lower surface of the first flexible substrate, and forming a second glass layer on an upper surface of the second flexible substrate.

In an embodiment of the inventive concept, an electrochromic device includes a first flexible substrate, fine pattern electrodes disposed on the first flexible substrate, and including first fine pattern electrode portions and second fine pattern electrode portions, electrochromic pixel patterns disposed on upper surface of the first fine pattern electrode portions, an insulation film covering upper surfaces of the second fine pattern electrode portions, an electrolyte layer disposed on the insulation film and on the electrochromic pixel patterns, an ion storage layer disposed on the electrolyte layer, a second electrode disposed on the ion storage layer, and a second flexible substrate disposed on the second electrode, wherein the electrochromic pixel patterns may include a conductive polymer.

In an embodiment, the electrochromic pixel patterns may expose the upper surfaces of the second fine pattern electrode portions.

In an embodiment, the insulation film may not cover upper surfaces of the electrochromic pixel patterns.

In an embodiment, the electrochromic device may further include a counter electrode connection portion.

In an embodiment, the electrochromic device may further include an electrode connection portion, wherein the electrode connection portion electrically may connect the counter electrode connection portion and the second electrode.

In an embodiment, the electrochromic device may further include a bonding portion, wherein the bonding portion is electrically connected to the counter electrode connection portion and the second fine pattern electrode portions.

In an embodiment, the electrochromic device may further include a first glass layer disposed on a lower surface of the first flexible substrate, and a second glass layer disposed on an upper surface of the second flexible substrate.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a plan view for describing a method for manufacturing an electrochromic device according to embodiment of the inventive concept;

FIG. 2A to FIG. 2G are cross-sectional views illustrating a method for manufacturing an electrochromic device according to embodiment of the inventive concept;

FIG. 3 is a cross-sectional view taken along line A-A′ of FIG. 1;

FIG. 4 is a plan view for describing an electrochromic device according to another embodiment of the inventive concept;

FIG. 5 is a cross-sectional view taken along line A-A′ of FIG. 4;

FIG. 6 is a cross-sectional view for describing an electrochromic device according to another embodiment of the inventive concept;

FIG. 7 is a graph showing a result of measuring a transmittance spectrum on an electrochromic device manufactured through an experimental example; and

FIG. 8 is a graph showing a result of measuring a change in transmittance according to a voltage application time of an electrochromic device manufactured through an experimental example.

### DETAILED DESCRIPTION

In order to facilitate sufficient understanding of the configuration and effects of the present invention, preferred embodiments of the present invention will be described with reference to the accompanying drawings. However, the present invention is not limited to the embodiments set forth below, and may be embodied in various forms and modified in many alternate forms. Rather, these embodiments are provided so that this disclosure will be thorough and complete, and will fully convey the scope of the present invention to those skilled in the art to which the present invention pertains. Those skilled in the art will appreciate that the inventive concepts may be executed in any suitable environment.

The terms used herein are intended to describe embodiments and are not intended to limit the present invention. In the present specification, singular forms include plural forms unless the context clearly indicates otherwise. As used herein, the terms “comprises” and/or “comprising” are intended to be inclusive of the stated elements, steps, operations and/or devices, and do not exclude the possibility of the presence or the addition of one or more other elements, steps, operations, and/or devices.

In the present specification, when a film (or a layer) is referred to as being on another film (or layer) or substrate, it may be formed directly on another film (or layer) or substrate, or a third film (or layer) may be interposed therebetween.

Although terms such as first, second, third, and the like are used in various embodiments of the present specification to describe various regions, films (or layers), and the like, the regions and films should not be limited by these terms. These terms are only used to distinguish a certain region or film (or layer) from another region or film (or layer). Therefore, a film referred to as a first film in any one embodiment may be referred to as a second film in another embodiment. Each embodiment described and illustrated herein also includes complementary embodiments thereof. Like reference numerals refer to like elements throughout the specification.

Unless otherwise defined, terms used in the embodiments of the present invention may be interpreted as meanings commonly known to those skilled in the art.

Hereinafter, the embodiments of the present invention will be described with reference to the accompanying drawings.

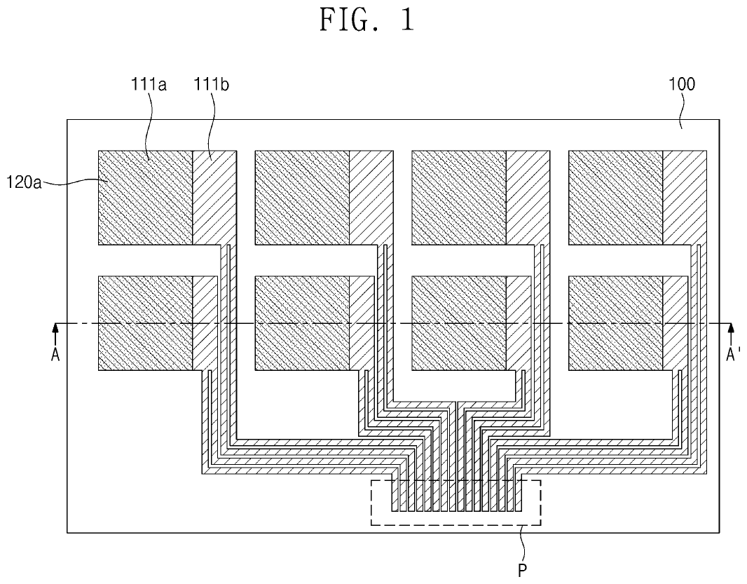

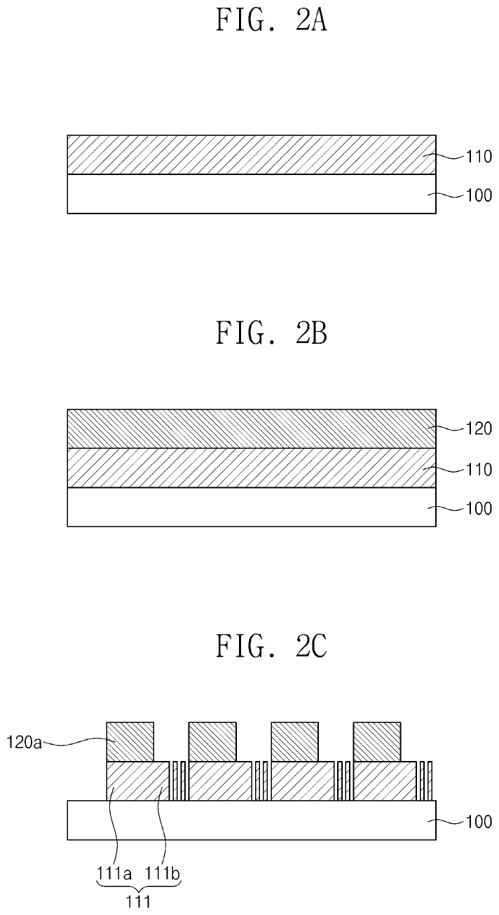

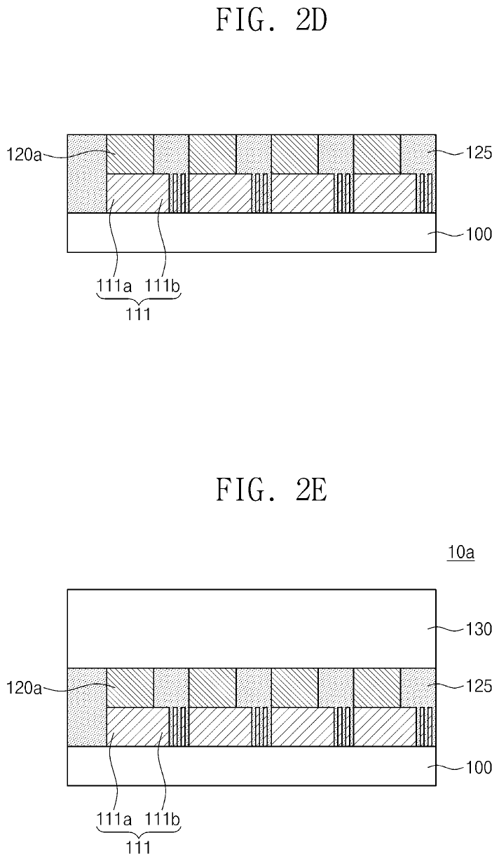

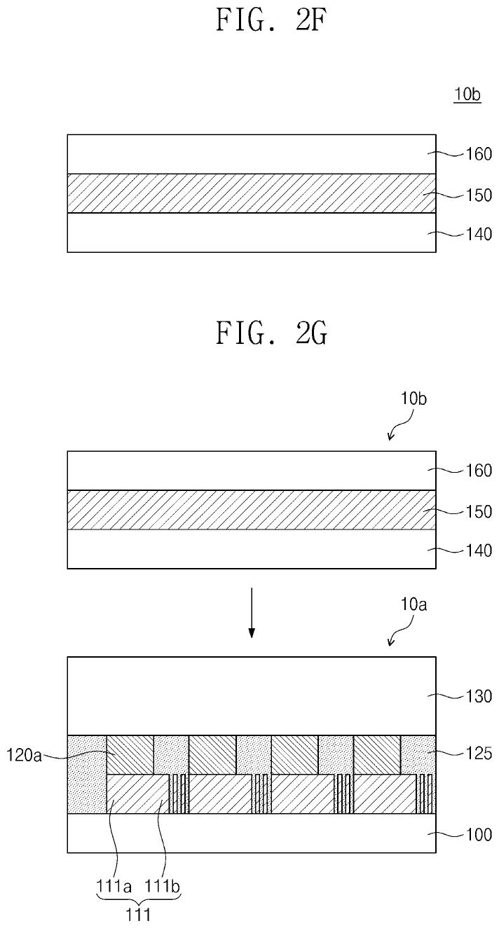

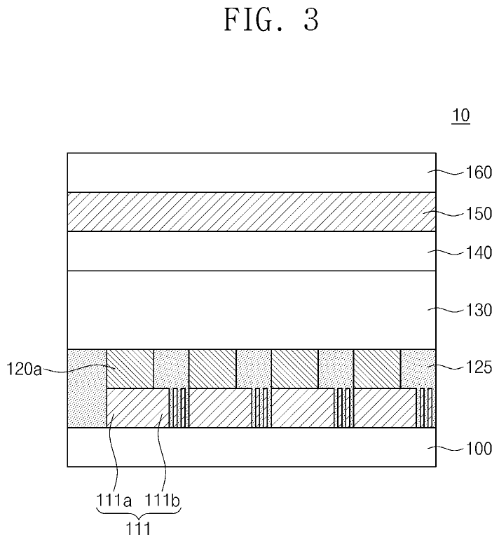

FIG. 1 is a plan view for describing a method for manufacturing an electrochromic device according to embodiment of the inventive concept. FIG. 2A to FIG. 2G are cross-sectional views illustrating a method for manufacturing an electrochromic device according to embodiment of the inventive concept. FIG. 3 is a cross-sectional view taken along line A-A′ of FIG. 1.

Referring to FIG. 2A, a first electrode 110 may be formed on a first flexible substrate 100. The first flexible substrate 100 may include a polymer, a fiber, a fabric, cellulose, or plastic. The first electrode 110 may have a thickness of approximately 0.1 nm to approximately 10 μm. The first electrode 110 may be transparent or translucent. The first electrode 110 may include a conductive material. The conductive material may include at least one of an indium zinc oxide (IZO), an indium tin oxide (ITO), a fluorine-doped tin oxide (FTO), an aluminum-doped zinc oxide (AZO), a boron-doped zinc oxide (BZO), a tungsten-doped zinc oxide (WZO), a tungsten-doped tin oxide (WTO), a gallium-doped zinc oxide (GZO), an antimony-doped tin oxide (ATO), an indium zinc oxide (IZO) dopes with indium, a titanium oxide (TiOₓ) doped with niobium (Nb), a single or multiple oxide-metal-oxide (OMO), a conductive polymer, a conductive organic molecule, carbon nanotube, graphene, silver nanowire, aluminum, silver, ruthenium, gold, platinum, tin, chromium, indium, zinc, copper, rubidium, nickel, a ruthenium oxide, a rubidium oxide, a tin oxide, an indium oxide, a zinc oxide, a chromium oxide, or molybdenum.

Referring to FIG. 2B, an electrochromic layer 120 may be formed on the first electrode 110. The electrochromic layer 120 may be formed uniformly on an upper surface of the first electrode 110 using a wire bar coater and the like. The electrochromic layer 120 may have a thickness of approximately 10 nm to approximately 10 μm. The electrochromic layer 120 may include a conductive polymer. The conductive polymer may include at least one of polythiophene, polythiophene derivatives, polyaniline, polyaniline derivatives, polypyrrole, or polypyrrole derivatives. The electrochromic layer 120 may include an organic chromic material or an inorganic chromic material. As an example, the organic chromic material may include at least one of phenothiazine derivatives, viologens, or viologens derivatives. As an example, the inorganic chromic material may include a tungsten oxide (WOₓ).

Referring to FIG. 2C, the electrochromic layer 120 may be etched to form electrochromic pixel patterns 120a. The first electrode 110 may be etched to form fine pattern electrodes 111. The fine pattern electrodes 111 may be disposed spaced apart from each other. The fine pattern electrodes 111 may include first fine pattern electrode portions 111a and second fine pattern electrode portions 111b. The second fine pattern electrode portions 111b may be connected to the first fine pattern electrode portions 111a without boundary surfaces.

The electrochromic pixel patterns 120a may be provided by being spaced apart from each other. The electrochromic pixel patterns 120a may be disposed on the first fine pattern electrode portions 111a. The electrochromic pixel patterns 120a may not be disposed the second fine pattern electrode portions 111b. The electrochromic pixel patterns 120a may expose upper surfaces of the second fine pattern electrode portions. The etching of the first electrode 110 and the etching of the electrochromic layer 120 may be performed in a single process. For example, the fine pattern electrodes 111 and the electrochromic pixel patterns 120a may be formed by a single laser etching process. Since formed by laser etching, the electrochromic pixel patterns 120a may be prevented from being damaged. Since the fine pattern electrodes 111 and the electrochromic pixel patterns 120a are formed by a single process, a manufacturing process of an electrochromic device may be simplified. The fine pattern electrodes 111 may be used as working electrodes.

Referring to FIG. 1, the second fine pattern electrode portions 111b may be formed by being extended to reach one region P on a substrate 100. In the one region P, the second fine pattern electrode portions 111b may be disposed by being spaced apart from each other.

Referring to FIG. 2D, an insulation film 125 may be formed on the upper surfaces of the second fine pattern electrode portions 111b. The insulation film 125 may further cover side surfaces of the electrochromic pixel patterns 120a, side surfaces of the first fine pattern electrode portions 111a, and side surfaces of the second fine pattern electrode portions 111b. A shadow mask may be formed on upper surfaces of the electrochromic pixel patterns 120a. The shadow mask may expose the upper surfaces of the second fine pattern electrode portions 111b. The forming of the insulation film 125 may be performed by a deposition process using the shadow mask. Therefore, the insulation film 125 may not be formed on the upper surfaces of the electrochromic pixel patterns 120a. That is, the insulation film 125 may expose the upper surfaces of the electrochromic pixel patterns 120a. The insulation film 125 may be formed, for example, by an e-beam vacuum deposition method. Since the insulation film 125 is formed by an e-beam vacuum deposition method, it is possible to selectively form the insulation film 125 only on the second fine pattern electrode portions 111b without damaging the electrochromic pixel patterns 120a. The insulation film 125 may prevent a leakage current between the fine pattern electrodes 111. The insulation film 125 may include a silicon oxide (SiO₂) or a metal oxide.

Referring to FIG. 2E, an electrolyte layer 130 may be formed on the electrochromic pixel patterns 120a and on the insulation film 125. The electrolyte layer 130 may come into contact with the upper surfaces of the electrochromic pixel patterns 120a. The electrolyte layer 130 may be electrically separated from the fine pattern electrodes 111 by the insulation film 125. The electrolyte layer 130 may be formed uniformly on the upper surfaces of the electrochromic pixel patterns 120a and on an upper surface of the insulation film 125 using a bar coater or slot-die coater. The electrolyte layer 130 may be a liquid, a gel, or a solid. The electrolyte layer 130 may include an organic or inorganic molecule. The organic or inorganic molecule may include a Li⁺ and/or H⁺ ion. The electrolyte layer 130 may include at least one of an organic molecule, a solvent, or an ionic liquid, and a polymer, and an ionic molecular sieve. The organic molecule, the solvent, or the ionic liquid may include at least one of propylene carbonate (PC), butylene carbonate (BC), gamma-butyrolactone (gamma-BL), gamma-valerolactone (gamma-VL), N-Methylmorpholine N-oxide (NMO), dimethyl carbonate (DMC), diethyl carbonate (DEC), ethyl methyl carbonate (EMC), propyl methyl carbonate (PMC), ethyl acetate (EA), ethylene blue (EB), water (H₂O), methylene blue (MB), morpholinium, imidazolium, a quaternary ammonium, a quaternary phosphonium, Br⁻, Cl⁻, NO₃⁻, BF₄⁻, or PF₆⁻. The polymer may include at least one of poly(ethylene glycol) (PEG), poly(methyl methacrylate) (PMMA), poly(butyl acrylate) (PBA), poly(vinyl butyrate) (PVB), polyvinyl alcohol (PVA), poly(ethylene oxide) (PEO), poly(propylene oxide) (PPO), polyacrylonitrile (PAN), poly(vinylidene fluoride) (PVDF), poly(vinylidene fluoride-co-hexafluoropropylene) (PVDF-HFP), or a block copolymer. The ionic molecular sieve may include at least one of a lithium ion product and a hydrogen ion product. The lithium ion product may include at least one of lithium perchlorate (LiClO₄), LiBF₄, LiPF₆, LiAsF₆, lithium triflate (LiTf) (LiCF₃SO₃), lithium imide (LiIm) (Li[N(SO₂CF₃)₂] and LiBeTi(Li[N(SO₂CF₂CF₃)₂]), LiBr, or LiI. The hydrogen ion product may include at least one of a hydrochloric acid (HCl), a sulfuric acid (H₂SO₄), a nitric acid (HNO₃), a phosphoric acid (H₃PO₄), an acetic acid (CH₃COOH), a perchloric acid (HClO₄), or a formic acid (HCOOH). Since the electrolyte layer 130 include the polymer, the viscosity and degree of viscosity may be controlled. In another example, the electrolyte layer 130 may include a polymer gel electrolyte. The forming of the electrolyte layer 130 may include applying a low-viscosity polymer gel electrolyte having a degree of viscosity of approximately 10 cP to approximately 100 cP, and then performing heat treatment to form a high-viscosity polymer gel electrolyte having good adhesion. The electrolyte layer 130 may provide electrolyte ions that involve in an electrochromic reaction. Accordingly, a lower structural body 10a may be provided. The lower structural body 10a may include the first flexible substrate 100, the fine pattern electrodes 111, the electrochromic pixel patterns 120a, the insulation film 125), and the electrolyte layer 130.

Referring to FIG. 2F, a second flexible substrate 160 coated with a second electrode 150 may be provided. The second electrode 150 may be formed on a lower surface of the second flexible substrate 160. The second flexible substrate 160 may include the same materials as those of the first flexible substrate 100 described with reference to FIG. 2A. The second electrode 150 may include the same materials as those of the first electrode 110 described with reference to FIG. 2A. The second electrode 150 may be transparent or translucent. The second electrode 150 may be used as counter electrodes of the fine pattern electrodes 111 described with reference to FIG. 2C.

An ion storage layer 140 may be formed on a lower surface of the second electrode 150. The ion storage layer 140 may be coated on the lower surface of the second electrode 150 by a vacuum or wet process. The ion storage layer 140 may have a thickness of approximately 1 nm to approximately 10 μm. The ion storage layer 140 may include an electrochromic material or indium tin oxide (ITO) nanoparticles (NP). When the ion storage layer 140 includes the electrochromic material, electrochromism may occur when a voltage is applied. For example, the electrochromic material may be an inorganic chromic material. The inorganic chromic material may include at least one of NiO, Prussian blue, triarylamine, or triarylamin derivatives. The ion storage layer 140 may be oxidized or reduced as the voltage is applied thereto, and may exchange ions with the electrochromic pixel patterns 120a described with reference to FIG. 2C. Accordingly, an upper structural body 10b may be provided. The upper structural body 10b may include the ion storage layer 140, the second electrode 150, and the second flexible substrate 160.

Referring to FIG. 2G and FIG. 3, the ion storage layer 140 of the upper structural body 10b may be coupled to the electrolyte layer 130 of the lower structural body 10a. Accordingly, manufacturing of an electrochromic device 10 may be completed. The electrochromic device 10 may include the lower structural body 10a and the upper structural body 10b. The electrochromic device 10 may include the first flexible substrate 100, the fine pattern electrodes 111, the electrochromic pixel patterns 120a, the insulation film 125, the electrolyte layer 130, the ion storage layer 140, the second electrode 150, and the second flexible substrate 160. The electrochromic device 10 manufactured by the manufacturing method according to an embodiment of the inventive concept may be curved or bent.

According to an embodiment, the method for manufacturing an electrochromic device described with reference to FIG. 2A to FIG. 2G may also be applied when the first flexible substrate 100 is a glass substrate, and when the second flexible substrate 160 is a glass substrate.

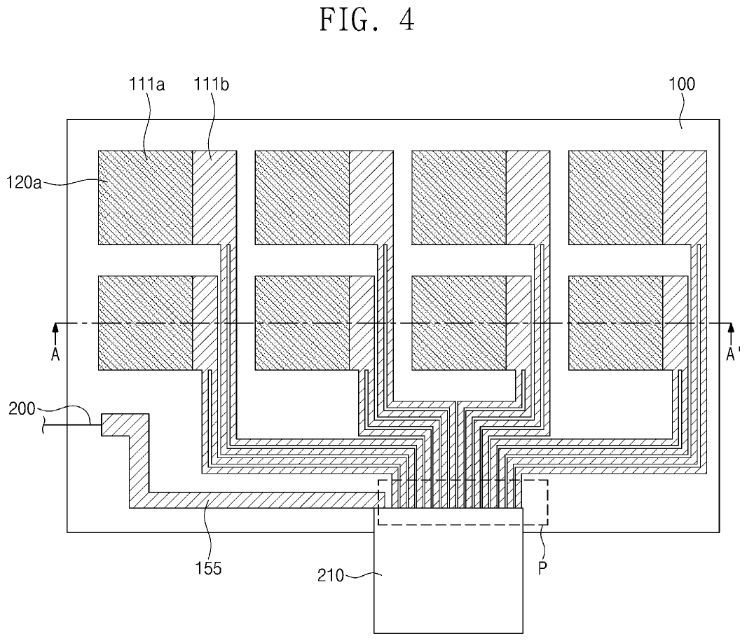

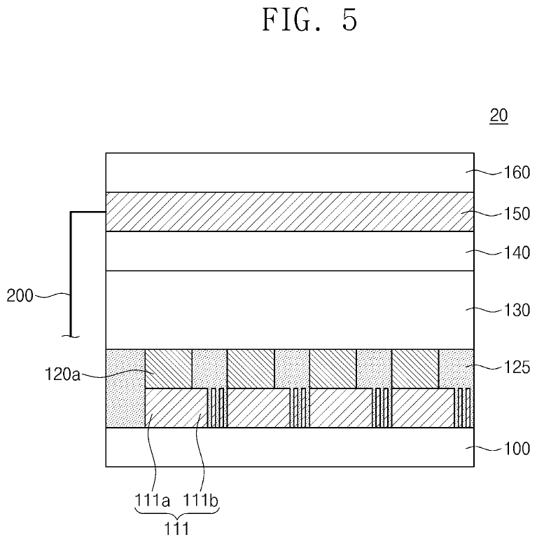

FIG. 4 is a plan view for describing an electrochromic device according to another embodiment of the inventive concept. FIG. 5 is a cross-sectional view taken along line A-A′ of FIG. 4.

Referring to FIG. 4 and FIG. 5, an electrochromic device 20 may include a first flexible substrate 100, fine pattern electrodes 111, a counter electrode connection portion 155, electrochromic pixel patterns 120a, an insulation film 125, an electrolyte layer 130, an ion storage layer 140, a second electrode 150, a second flexible substrate 160, an electrode connection portion 200, and a bonding portion 210. The electrode connection portion 200 of FIG. 4 and FIG. 5 is schematically illustrated.

As shown in FIG. 4, one end of the electrode connection portion 200 may be electrically connected to the counter electrode connection portion 155. The electrode connection portion 200 may be manufactured by using a silver (Ag) paste. As shown in FIG. 5, the other end of the electrode connection portion 200 may be electrically connected to the second electrode 150. Therefore, when a voltage is applied to the electrochromic device 20, electrons may move through the fine pattern electrodes 111, the counter electrode connection portion 155, the electrode connection portion 200, and the second electrode 150.

As shown in FIG. 4, the bonding portion 210 may be connected to each of second fine pattern electrodes 111b and to the counter electrode connection portion 155 on one region P. For example, the bonding portion 210 may be formed through tab bonding. The bonding portion 210 may be connected to a driving circuit of a display device. A voltage may be applied to the electrochromic device 20 through the bonding portion 210. The bonding portion 210 is flexible and bendable.

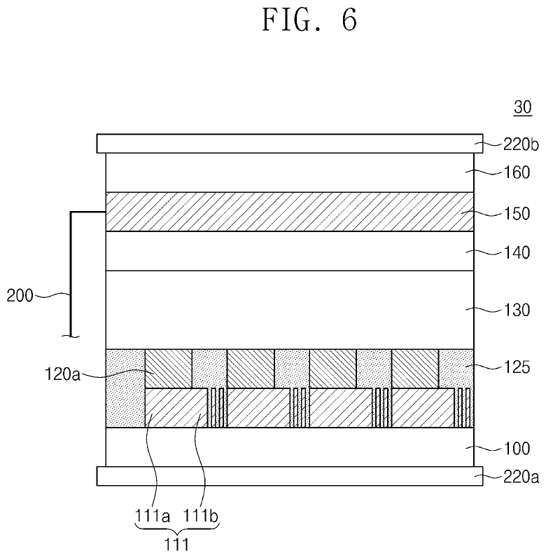

FIG. 6 is a cross-sectional view for describing an electrochromic device according to another embodiment of the inventive concept.

Referring to FIG. 6, an electrochromic device 30 may include a first flexible substrate 100, fine pattern electrodes 111, electrochromic pixel patterns 120a, an insulation film 125, an electrolyte layer 130, an ion storage layer 140, a second electrode 150, a second flexible substrate 160, an electrode connection portion 200, and a bonding portion 210. The electrochromic device 30 may further include at least one of a first glass layer 220a and a second glass layer 220b.

The first glass layer 220a may be disposed on a lower surface of the first flexible substrate 100. The second glass layer 220b may be disposed on an upper surface of the section flexible substrate 160. The first glass layer 220a may be bonded to the first flexible substrate 100 by using a PVA or EVA film. The second glass layer 220b may be bonded to the second flexible substrate 160 by using a PVA or EVA film. The electrochromic device 30 according to embodiments may be used in a electrochromic display device for a curved vehicle window.

Manufacturing and evaluation of an electrochromic device according to an experimental example will be described.

### Experimental Example

A polyethylene terephthalate (PET) substrate was prepared as a first flexible substrate. A transparent indium tin oxide (ITO) was coated as a first electrode on the first flexible substrate to have a sheet resistance of approximately 30Ω.

An electrochromic layer was provided as follows. First, 0.4 g of poly(3-hexylthiophene-2,5-diyl) (P3HT) was added to 35 g of chlorobenzene and subjected to sonication dispersion for 30 minutes to prepare a coating solution of 1.27 wt %. Impurities of the coating solution were removed by using a 0.8 μm syringe filter. A 300 mm long and 0.5 inch thick No. 8 wire bar was used for coating. The first flexible substrate coated with the first electrode was fixed on the floor with a tape, and then the wire bar was placed at a suitable position on the substrate. The coating solution was spayed in front of the fixed wire bar, and then the wire bar was coated in one direction. After the coating, natural drying was performed in a hood for about 30 minutes, followed by heat-treatment in an oven at 60° C. for 30 minutes. Finally, a P3HT electrochromic layer having a transmittance of about 8% at 550 nm was prepared.

Electrochromic pixel patterns and fine pattern electrodes were formed by laser etching on the electrochromic layer and on the first electrode. As the first step, the laser etching was performed in an X-axis direction. As the second step, the laser etching was performed in an Y-axis direction. As the third step, the P3HT electrochromic layer was etched to finally form the fine pattern electrodes and the electrochromic pixel patterns. The electrochromic pixel patterns had dimensions of 9 mm×9 mm and a pitch of 11 mm, and an interval between the electrochromic pixel patterns was 2 mm. The number of the electrochromic pixel patterns was 36 (6×6). A line width and an interval of second fine pattern electrode portions were approximately 100 μm, respectively. In the electrochromic pixel patterns, the second fine pattern electrode portions having a shape in which two lines were connected was formed. A counter electrode connection portion was also formed.

An insulation film was provided on the second fine pattern electrode portions. The insulation film was provided to cover side surfaces of the electrochromic pixel patterns and to cover exposed surfaces of the fine pattern electrodes. A mask was formed on upper surfaces of the electrochromic pixel patterns. The mask exposed upper surfaces of the second fine pattern electrode portions. The insulation film was formed using an e-beam vacuum deposition method. As the insulation film, a silicon oxide (SiO₂) was used. The insulation film was formed to have a thickness of about 200 nm.

An electrolyte layer was provided on the upper surfaces of the electrochromic pixel patterns. The electrolyte layer included an adhesive PVB-based polymer. The electrolyte layer was coated using a bar coater.

A PET substrate was prepared as a second flexible substrate. A transparent indium tin oxide (ITO) was coated as a second electrode on the second flexible substrate to have a sheet resistance of approximately 30Ω. a An ion storage layer was provided on the second electrode. As the ion storage layer, indium tin oxide (ITO) nanoparticles (NP) were used. The ITO NP were coated uniformly on the second electrode using a spin coater. After the coating, heat-treatment was performed at 100° C. for 5 minutes. At this time, the thickness of the ion storage layer was approximately 3.5 μm.

An electrochromic device was manufactured by coupling the electrolyte layer and the ion storage layer. A silver (Ag) paste was used as an electrode connection portion. A counter electrode connection portion was electrically connected to the second electrode through the electrode connection portion. A bonding portion was made by using tab bonding. A driving circuit and the electrochromic device were electrically connected through the bonding portion. A driving voltage was applied to the electrochromic element through the bonding portion.

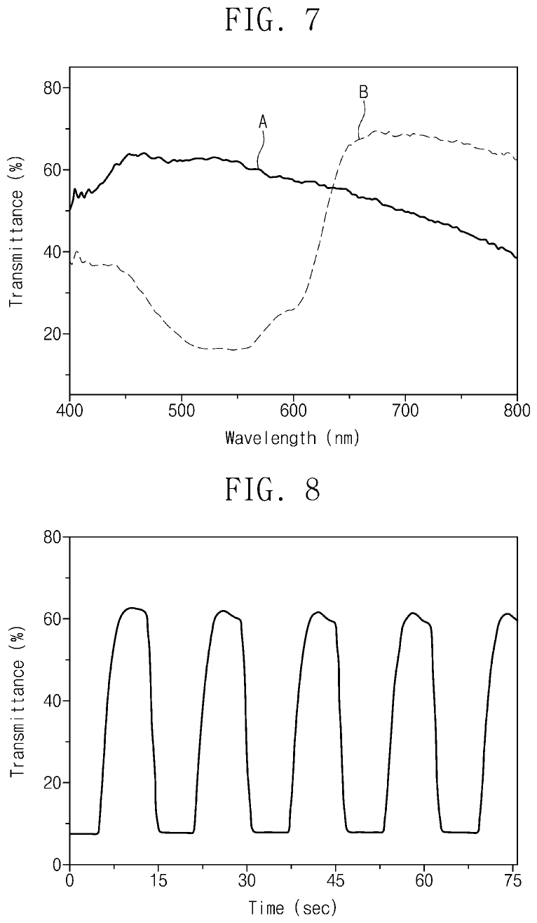

FIG. 7 is a graph showing a result of measuring a transmittance spectrum on the electrochromic device manufactured through Experimental Example. Coloring was performed at −0.5 V for 10 seconds, and bleaching was performed at 2.0 V for 10 seconds. The transmittance spectrum was measured at a wavelength of 533 nm.

Referring to FIG. 7, it has been observed that the electrochromic device of Experimental Example exhibits a bleached state A and a colored state B depending on a voltage application condition. It can be seen that the transmittance spectrum exhibits a peak coloration state at the wavelength of 533 nm. In the colored state B, a pink color is shown, and in the bleached state A, a transparent color is shown.

FIG. 8 is a graph showing a result of measuring a change in transmittance according to a voltage application time of the electrochromic device manufactured through Experimental Example. At this time, applying of a voltage was performed by applying a coloring voltage of −0.5 V for 8 seconds, and then applying a bleaching voltage of 2.0 V for 8 seconds, repeatedly.

Referring to FIG. 8, a bleaching chromic rate and a coloring chromic rate were specified as 3.1 seconds and 1.8 seconds, respectively, based on a change in the transmittance of 90%. The transmittance of bleaching and the transmittance of coloring at the wavelength of 533 nm were measured to be 61.5% and 7.8%, respectively. As a result, it can be confirmed that the photoelectric properties of the electrochromic device were improved.

According to embodiments of the inventive concept, an electrochromic device includes a conductive polymer in an electrochromic layer, and includes an insulation film capable of preventing a leakage current, and thus may have improved photoelectric properties. At this time, there may be provided a method for manufacturing an electrochromic device, the method simplified by etching electrochromic pixel patterns and fine pattern electrodes in a single process.

Although the embodiments of the present invention have been described with reference to the accompanying drawings, those skilled in the art will appreciate that the present invention can be variously modified and changed without departing from the spirit and scope of the present invention as set forth in the following patent claims. In addition, the embodiments disclosed in the present invention are not intended to limit the technical spirit of the present invention, and all technical concepts falling within the scope of the following claims and equivalents thereof are to be construed as being included in the scope of the present invention.

What is claimed is:

1. A method for manufacturing an electrochromic device, the method comprising:
forming a first electrode on a first flexible substrate;
forming an electrochromic layer on the first electrode;
etching the electrochromic layer to form electrochromic pixel patterns;
etching the first electrode to form fine pattern electrodes including first fine pattern electrode portions and second fine pattern electrode portions;
forming an insulation film on upper surfaces of the second fine pattern electrode portions; and
forming an electrolyte layer on the insulation film and on the electrochromic pixel patterns,
wherein:
the electrochromic pixel patterns are disposed on upper surface of the first fine pattern electrode portions; and
the etching of the first electrode and the etching of the electrochromic layer are performed in a single process.

2. The method of claim 1, wherein the electrochromic pixel patterns expose the upper surfaces of the second fine pattern electrode portions.

3. The method of claim 1, wherein the insulation film does not cover upper surfaces of the electrochromic pixel patterns.

4. The method of claim 1, wherein the electrochromic layer comprises a conductive polymer.

5. The method of claim 1, wherein the forming of electrochromic pixel patterns and the forming of fine pattern electrodes are performed by a single laser etching process.

6. The method of claim 1, wherein the forming of an insulation film is performed by an e-beam vacuum deposition method using a mask.

7. The method of claim 1, wherein the electrolyte layer comprises an adhesive polymer gel electrolyte.

8. The method of claim 1, wherein the insulation film comprises a silicon oxide (SiO₂) or a metal oxide.

9. The method of claim 1, further comprising:
forming a second electrode on a lower surface of a second flexible substrate;
forming an ion storage layer on a lower surface of the second electrode; and
coupling the electrolyte layer and the ion storage layer.

10. The method of claim 1, further comprising forming a counter electrode connection portion.

11. The method of claim 10, further comprising forming an electrode connection portion,
wherein the electrode connection portion electrically connects the counter electrode connection portion and the second electrode.

12. The method of claim 11, further comprising forming a bonding portion,
wherein the bonding portion is electrically connected to the counter electrode connection portion and the second fine pattern electrode portions.

13. The method of claim 12, further comprising:
forming a first glass layer on a lower surface of the first flexible substrate; and
forming a second glass layer on an upper surface of the second flexible substrate.

14. An electrochromic device comprising:
a first flexible substrate;
fine pattern electrodes disposed on the first flexible substrate, and including first fine pattern electrode portions and second fine pattern electrode portions;
electrochromic pixel patterns disposed on upper surface of the first fine pattern electrode portions;
an insulation film covering upper surfaces of the second fine pattern electrode portions;
an electrolyte layer disposed on the insulation film and on the electrochromic pixel patterns;
an ion storage layer disposed on the electrolyte layer;
a second electrode disposed on the ion storage layer; and
a second flexible substrate disposed on the second electrode,
wherein the electrochromic pixel patterns include a conductive polymer.

15. The electrochromic device of claim 14, wherein the electrochromic pixel patterns expose the upper surfaces of the second fine pattern electrode portions.

16. The electrochromic device of claim 14, wherein the insulation film does not cover upper surfaces of the electrochromic pixel patterns.

17. The electrochromic device of claim 14, further comprising a counter electrode connection portion.

18. The electrochromic device of claim 17, further comprising an electrode connection portion,
wherein the electrode connection portion electrically connects the counter electrode connection portion and the second electrode.

19. The electrochromic device of claim 18, further comprising a bonding portion,
wherein the bonding portion is electrically connected to the counter electrode connection portion and the second fine pattern electrode portions.

20. The electrochromic device of claim 14, further comprising:
a first glass layer disposed on a lower surface of the first flexible substrate; and
a second glass layer disposed on an upper surface of the second flexible substrate.
